(19) United States
(12) Patent Application Publication
(10) Pub. No.: US 2026/0255455 A1
(43) Pub. Date: Aug. 27, 2026

(54) CURRENT SINK WITH BYPASS FOR AN LED CHAIN

(71) Applicant: Diehl Aerospace GmbH, Ueberlingen (DE)

(72) Inventors: Uwe NIEBERLEIN, Roth (DE); Gunther KONINGER, Neuhof (DE)

(73) Assignee: Diehl Aerospace GmbH, Ueberlingen (DE)

(21) Appl. No.: 19/545,786

(22) Filed: Feb. 20, 2026

(30) Foreign Application Priority Data
Feb. 24, 2025 (DE) 102025106800.3

(51) Int. Cl. H05B 45/40; H05B 45/20; H05B 45/325; H05B 45/34; H05B 45/54

(52) U.S. Cl. CPC H05B 45/40; H05B 45/20; H05B 45/325; H05B 45/34; H05B 45/54

(57) ABSTRACT

A current sink (22) contains two supply poles (28a,b) for a continuous DC voltage (UG) and a current path (30) connecting said supply poles that, during operation (B), carries a total current (IG), the following being connected in series in the current path (30): a connection (32) for the LED chain (20), a shunt resistor (36) for mapping the total current (IG) to a measurement voltage (UM), a switch (40) for opening or closing the current path (30), a controllable resistor element (42) containing a parallel connection comprising a load resistor (44) and a bypass path (46) containing a controllable current brake (48) for controlling a bypass current (IB) through the bypass path (46), and a control unit (60) to take the measurement voltage (UM) as a basis for controlling the current brake (48) in regard to the magnitude of the bypass current (IB) such that, when the switch (40) is closed, a predeterminable total current (IG) is produced in the current path (30).

A light source (6) for a light device (4) of an aircraft (2) contains the current sink (22) and the LED chain (20) connected to the connection (32).

A light device (4) for an aircraft (2) contains at least one light source (6a-c).

### BACKGROUND OF THE INVENTION

The present invention relates to a current sink for an LED chain, i.e. a series connection comprising multiple LEDs (light-emitting diode). Such a current sink is used to set a desired current through the LED chain and thus the LEDs, the voltage dropped across the LED chain for the same current being able to vary greatly from one LED chain to another, e.g. for production reasons.

### DISCUSSION OF THE PRIOR ART

DE 10 2012 107 882 A1 discloses a circuit for controlling a multiplicity of LEDs connected in series (LED chain). According to one example, the circuit comprises a switch-mode converter that can be operated as a current source and that is connected to the multiplicity of LEDs in order to supply them with a constant load current. The switch-mode converter comprises an inductor connected in series with the multiplicity of LEDs in such a way that the same load current flows through the inductor and the multiplicity of LEDs. No capacitor is coupled between the inductor and the multiplicity of LEDs. A potential-free driver circuit is connected in parallel with each individual LED (from the multiplicity of LEDs). The potential-free driver circuit is designed to control the intensity of the light imitated by the respective LED according to an associated modulated input signal by accepting all or at least part of the load current of said LED, thereby forming a bypass to the respective LED.

### SUMMARY OF THE INVENTION

The present invention is directed to improvements with regard to a current sink for an LED chain.

More specifically, the present invention is directed to a current sink for an LED chain having an upper and a lower supply pole that are fed from a continuous DC voltage (UG) during operation (B) as intended, and having a single current path connecting the two supply poles that, during operation (B), carries a total current (IG), the following being connected in series in the current path:
a two-pole connection (32) for the LED chain (20),
a shunt resistor that maps the total current (IG) currently flowing through the current path to a present measurement voltage (UM),
a switch for opening or closing the current path,
a controllable resistor element containing a parallel connection comprising a load resistor and a bypass path,
the bypass path containing a controllable current brake that controls the magnitude of a bypass current (IB) through the bypass path,
having a control unit that is connected to the current brake and configured to take the measurement voltage (UM) as a basis for controlling the current brake in regard to the magnitude of the bypass current (IB) such that, when the switch is closed, a predeterminable total current (IG) is produced in the current path.

The current sink according to the present invention is a current sink for an LED chain. Such an LED chain is a two-pole network and contains a series connection comprising multiple LEDs in a single branch. During operation, the LED chain carries a total current. The same total current thus flows through the branch and each of the LEDs. A given total current results in—depending on the individual entity of the LED chain—a voltage that is dropped across the entire chain. This voltage can vary greatly from one instance to another of such—including identical—chains, e.g. between 20V and 35V.

The current sink contains an upper and a lower supply pole. During operation of the current sink as intended (with an LED chain connected), the supply poles are fed from a continuous DC voltage. “Continuous DC voltage” means that even a PWM (Pulse Width Modulation) mode of the LED chain involves an (in particular constant) DC voltage being continuously applied, i.e. the continuous DC voltage is not switched in line with a PWM.

The current sink contains a single current path. The current path connects the two supply poles. During operation, the current path carries the total current mentioned above. The total current can assume different values and can even be zero, i.e. is in particular variable over time, and is, as intended, caused by the continuous DC voltage applied to the current sink with the connected LED chain. The total current may also be switched in a PWM cycle (see below).

The current path contains the following elements connected in series, all of which are components of the current sink:
a two-pole connection for the LED chain,
a shunt resistor
a switch and
a controllable resistor element.

These are explained in more detail below. All of the elements in the series connection (and the LED chain, see below) thus always currently carry the same total current during operation.

The two-pole connection can be used to connect a or the LED chain to the current sink. To this end, the LED chain is included in the series connection, or becomes part of the series connection. In other words, the series connection between the two supply poles is broken at the point of the connection and the LED chain can be or is inserted there. The LED chain is thus part of the current path and carries the same total current.

Although the invention is directed to an LED chain here, the current sink can also be used to operate other electrical loads. In other words, any load in the form of a two-pole network intended to carry a current using a current sink can be connected to the connection.

The shunt resistor maps the current currently flowing through the current path, i.e. the total current, to a present measurement voltage. By evaluating the present measurement voltage, it is thus possible to determine the present total current.

The switch is used or is configured to open or close the current path. In other words, opening the switch can be used to interrupt the current path so that there is then no flow of current through the current path. “No flow of current” should be understood to mean that an insignificant reverse current can still flow, e.g. if the switch is an electronic switch. When the switch is closed, the current path is also connected so that the total current can or does flow through the current path. In particular, there is then no or only a negligible voltage drop across the switch.

The controllable resistor element contains or is a parallel connection comprising a load resistor and a bypass path. During operation, the parallel connection carries the total current. The load resistor carries a load current. The bypass path carries a bypass current during operation. The load current is therefore the total current minus the bypass current.

The bypass path contains a controllable current brake, in particular a transistor. During operation, i.e. when the switch is closed, the magnitude of the bypass current is controllable or controlled by the current brake. In other words, depending on the control of the current brake, more or less bypass current is “subtracted” from the load resistor, so that the load current falls as the bypass current rises, and vice versa. It is thus possible to adjust the bypass current and thereby control the voltage dropped across the resistor element in the series connection. In particular, the voltage ratios in the series connection can thus be adapted for the current/voltage requirements of the LED chain. This can be done in particular independently of the desired total current.

The elements of the current sink connected in series are thus listed in full.

The current sink additionally contains a control unit (i.e. which is not part of the series connection). Said control unit is configured to take the measurement voltage as a basis for controlling the transistor in regard to the magnitude of the bypass current such that—when the switch is closed—a predeterminable total current is produced in the current path. The following is thus possible: A given continuous DC voltage or a given voltage applied to the supply poles can result in the load current and thus the voltage dropped across the resistor element being kept the same, but the total current being varied by passing additional bypass current through the bypass path.

One consideration here is that, in particular in the case of an LED chain, the voltage drop across the latter for a total current of the same magnitude can vary greatly from one instance to another. For this reason, the voltage dropped across the resistor element in the series connection needs to be adjusted given the same magnitude of the continuous DC voltage. This can be done only by adjusting the load current. The total current can then be set to a desired value by controlling the bypass current.

The control unit (especially if the current brake is a transistor) is in particular in the form of at least part of a microcontroller containing an output for a controllable analogue voltage. The analogue voltage is then fed to the transistor as a control voltage in order to control the bypass current.

The invention yields a design of analogue fast simplified current sinks, in particular for operation in LED light devices, having a current brake, in particular as a control semiconductor, and a switch.

A current sink is described that can be used to switch LEDs of an LED chain quickly despite a simple design and that is no longer reliant/dependent on the character properties of control diodes used in circuits customary in the art.

In a preferred embodiment, the switch is arranged in the current path at the lower supply pole as the first element of the series connection. In other words, the switch is the element of the series connection that is arranged closest to the lower supply pole in the current path. In particular if the lower supply pole is an earth pole, the switch thus has its one pole connected to earth and can thus be produced particularly easily and cost-effectively.

In a preferred embodiment, the connection for the LED chain is arranged in the current path at the upper supply pole as the first element of the series connection. In other words, the connection, and thus e.g. an LED chain as a load, is the element of the series connection that is arranged closest to the upper supply pole in the current path. If the upper supply pole has a higher electrical potential (in particular positive operating potential) applied to it than the lower supply pole (in particular earth), only the load, e.g. the LED chain, is exposed to the highest potential. All other elements of the series connection are exposed to lower potentials or earth. The elements of the current sink are thus protected.

In a preferred embodiment, the shunt resistor is arranged in the current path closer to the lower supply pole than the resistor element and the connection. Analogously to the designs above (potentials, earth at the lower supply pole), the shunt resistor is then also exposed to the lowest potentials in the current sink. In particular if the lower supply pole as earth pole is followed by only the switch and then the shunt resistor of the series connection, one pole of the shunt resistor is also at earth potential when the switch is closed (assuming no or only an insignificant voltage drop across the closed switch).

In a preferred embodiment, the switch is a PWM switch for a PWM mode of the LED chain. In other words, there is provision in this embodiment for the LED chain to be controlled in a PWM mode, the PWM mode being provided in particular exclusively via the PWM switch, specifically when the continuous DC voltage (not switched by means of PWM) is applied between the supply poles as intended. This avoids subjecting the entire current sink to a changing supply voltage. The current sink can actually (in line with PWM continuously) be supplied with the continuous DC voltage, which simplifies control of the current sink or the current sink with the connected LED chain.

The present invention is also directed to a light source for a light device of an aircraft. The light source contains the current sink according to the invention. The light source also contains the LED chain mentioned above. The LED chain contains a plurality of LEDs connected in series. The LED chain is connected in the light source between the two connecting poles of the two-pole connection. In other words, the LED chain in the light source forms another element of the series connection in the current path. During operation, both the LED chain and each of the LEDs therefore carry the total current that flows through the current sink or the current path thereof.

The light source and at least some of the possible embodiments thereof and the respective advantages have already been explained analogously in connection with the current sink according to the invention. In particular, this means that the preferred embodiments mentioned above in connection with the current sink also form preferred embodiments of the light source.

The present invention is further directed to
a light device of an aircraft or for an aircraft as already explained above. The light device contains at least one of the light sources according to the invention.

The light device and at least some of the possible embodiments thereof and the respective advantages have already been explained analogously in connection with the current sink and light source according to the invention. In particular, this means that the preferred embodiments mentioned above in connection with the current sink and light source also form preferred embodiments of the light device.

In particular, the light device contains multiple light sources according to the invention. For example, a multi-colour light device can thus be realized, which contains as the first light source a light source having a white LED chain (LEDs generate white light), a second light source having red LEDs, a third light source having green LEDs and a fourth light source having blue LEDs.

In a preferred embodiment, the light device contains at least two of the light sources according to the invention. The light device also contains an overall controller for the light device. The control unit of at least one of the light sources according to the invention, in particular of multiple or all of the light sources according to the invention, is in the form of at least part of the overall controller. In other words, a single overall controller can undertake control of at least one, in particular multiple or all, of the control units of the light sources according to the invention, which simplifies the overall arrangement.

In a preferred embodiment, the light device contains a PWM element. This is used or is configured to control at least one, in particular multiple or all, of the light sources according to the invention using a respective PWM signal. The PWM element is connected to the switch of the respective light source for this purpose, which is why the respective light source then has the embodiment explained above that the switch thereof is a PWM switch. The PWM element is configured to control the respective switch using the respective PWM signal. This means that at least one, in particular multiple or all, of the light sources according to the invention in the light device can be controlled particularly easily by a central PWM element. In particular, the PWM element is also in the form of at least part of the overall controller of the light device.

In a preferred embodiment, the light device contains a supply module. The supply module is used or is configured to supply the supply poles of at least one, in particular multiple, in particular all, of the light sources according to the invention with a respective continuous DC voltage. This means that the light sources can be supplied with energy particularly easily.

In a preferred variant of this embodiment, the supply module is configured to select or change the magnitude of the respective continuous DC voltage for a respective light source according to the invention on the basis of the magnitude of the bypass current in the respective light source. In particular, it is thus possible to lower the continuous DC voltage to a minimum necessary level, so that the smallest possible or no bypass current flows in the respective light source. This reduces the power consumption and heat generation of the respective light source or current sink.

The invention is based on the following findings, observations or considerations and has furthermore the following preferred embodiments. These embodiments are also sometimes referred to as “the invention” for the sake of simplicity. The embodiments may in this case also contain parts or combinations of the aforementioned embodiments or correspond to them and/or possibly also include embodiments which have not yet been mentioned.

The invention is based on the following finding: In order to be able to switch the LEDs of an LED chain quickly at all operating points and to be able to ensure a constant current in the LEDs over temperature and all tolerances, a current source with transistors connected in parallel that are controlled is set up in practice. This is complex and costs a lot of money, components, current centring, vibration suppression, control loop.

One notion would be a first reduction of the transistors, but the starting behaviour is then somewhat slower, since a regulating control diode is started up with a very high resistance in order to avoid unnecessary losses due to control power. This also repeatedly causes slow starting behaviour in the PWM mode at low low-dim levels.

The invention is based on the notion that previous current sinks were produced in hardware with many expensive components (e.g. control diodes). The hardware (control diode) is controlled according to the invention by control/software (control unit based on voltage/current measurement using the shunt resistor).

This invention therefore describes a current sink that can be used to switch LEDs quickly despite a simple design and that is no longer reliant/dependent on the character properties of the control diodes.

Fundamental advantages are:
lower costs
market protection
approximately 40 units per 42-inch device with 4-inch control.

The invention results in the RC costs (recurring costs for each device) of the current sinks being reduced. These become cheaper and faster.

Basic ideas of the invention are also:
optionally an adjustable voltage source (supply module, continuous DC voltage) to increase efficiency,
adjustable voltage for controlling the current brake (transistor), e.g. PWM and low pass filter or DAC (digital/analogue converter) for current correction
transistor as current brake in current source configuration
voltage measurement by the shunt resistor supplies the LED current when the switch is closed
switch as “low-R switch”

switch for supplying the LED PWM.

One concept of the invention is the following: A transistor (current brake) is operated in a basic current sink circuit. With a low-resistance low-cost switch, e.g. a MOSFET, which can be very small and inexpensive, e.g. 5 ct, as it does not have to dissipate any power loss, the LED is PWM-switched. In the ON state (switch closed), a voltage corresponding to the present current (total current) can be measured across the shunt resistor(s). The control unit (PWM element) can now correct the light by tracking the LED PWM cycle. In addition, the voltage source (supply module, continuous DC voltage), which determines the operating point of the transistor, can correct the voltage, e.g. using a DAC or a PWM with a low pass filter, and can thus correct the operating point of current. In addition, the control unit can optionally send a correction to the LED voltage source (supply module, continuous DC voltage) in order to optimize the efficiency of the device.

Since the transistor is now switched directly without control intervention, very fast current adjustment is achieved by the LEDs. The settling time is now determined only by the transistor and the switch. However, both are very fast components that are now operated only in controlled mode during the change of state.

The great advantage is now that centring and vibration suppression, which add little, can be omitted; the main power loss occurs in cheap resistors, which can easily be routed in series. The transistor itself essentially undertakes the current regulation/control and can even become smaller, since its peak power loss now occurs only at half the LED current and half the power loss. The rest occurs in the resistors.

The shunt voltage can now be freely selected and is no longer fixed at 1.24 V. A reduction leads to higher overall efficiency.

### BRIEF DESCRIPTION OF THE DRAWINGS

Further features, effects and advantages of the invention are obtained from the description of a preferred exemplary embodiment of the invention that follows and the accompanying figures, in which, in each case in a basic schematic diagram:

FIG. 1 shows an aircraft with a light device, containing a light source comprising an LED chain and a current sink,

FIG. 2 shows an alternative light device with three light sources.

### DETAILED DESCRIPTION OF THE INVENTION

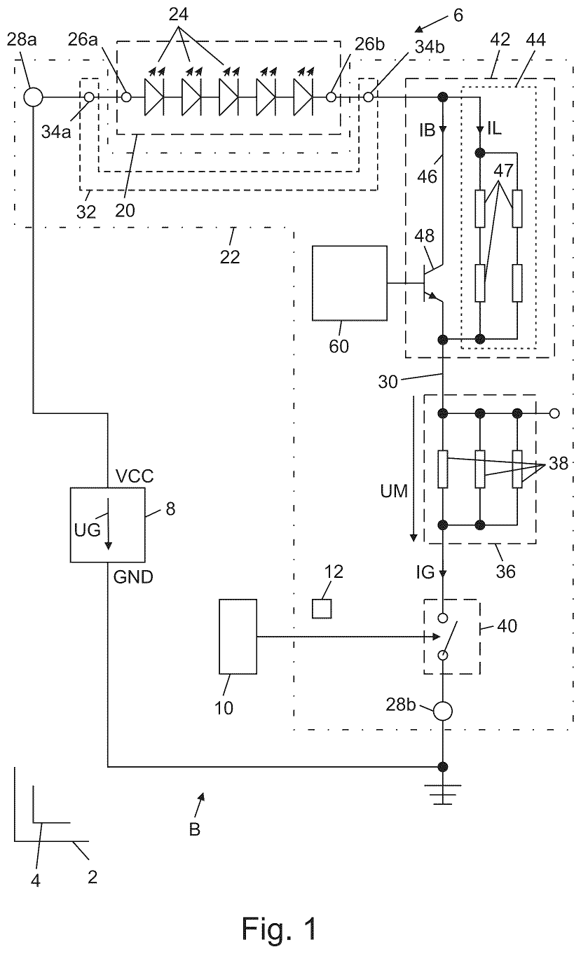

FIG. 1 shows a detail from an aircraft 2, which is not shown in greater detail. The aircraft 2 contains a light device 4 for the aircraft 2. The light device 4 contains a light source 6 and also an energy source 8 and a PWM control device 10.

FIG. 1 shows the light device 4 during operation B as intended. The energy source 8 therein generates a continuous DC voltage UG between an earth potential GND and a positive operating potential VCC. The PWM control device 10 generates a PWM signal 12. The light source 6 contains an LED chain 20 and also a current sink 22 for the LED chain 20 or operation B thereof. The LED chain 20 here is a series connection comprising a plurality of LEDs 24, only five of which are shown as an example in FIG. 1 for the sake of clarity. The LED chain 20 therefore has two electrical contacts 26a,b.

The current sink 22 for the LED chain 20 contains an upper supply pole 28a and a lower supply pole 28b. During operation B, the two supply poles 28a,b are fed from the continuous DC voltage UG, that is to say the energy source 8 is connected to the two supply poles 28a,b.

The current sink 22 contains a current path 30 that connects the two supply poles 28a,b to one another. During operation B, the current path 30 carries a total current IG that is caused by the continuous DC voltage UG and varies over time. The total current IG can also become zero if a switch 40 is open, see below.

The following components are connected in series in the current path 30:

The upper supply pole 28a is followed by a two-pole connection 32 of the current sink 22 having two connecting poles 34a,b. The LED chain 20 has its contacts 26a,b connected to the latter. The LED chain thus also forms an element of the series connection in the current path 30.

The current sink 22 or the series connection thereof also contains a shunt resistor 36, which, here, is in the form of a parallel connection comprising multiple single shunts 38 (resistors), only three of which are shown symbolically in FIG. 1.

The shunt resistor 36 maps the total current IG currently flowing through it and thus the current path 30 to a present measurement voltage UM. Based on the measurement voltage UM, the total current IG currently flowing in the current path 30 is therefore known.

The current sink 22 or the series connection thereof also contains a switch 40 for opening, i.e. interrupting, or closing the current path 30. In the open state, the flow of current is interrupted, i.e. the total current IG is zero. In the closed state, the total current IG flows through the switch 40 without (significant) voltage being dropped across said switch.

The current sink 22 or the series connection thereof also contains a controllable resistor element 42. Said resistor element consists of a parallel connection comprising a load resistor 44 with a bypass path 46. The load resistor 44 is also formed by a resistor network of single load resistors 47, only four of which are shown symbolically here. The bypass path 46 contains a current brake 48 in the form of a bypass transistor. During operation B, the entire load resistor 44 again carries the total current IG. In this case, a load current IL flows through the load resistor 44. A bypass current IB flows through the bypass path 46. The load current IL and the bypass current IB collectively yield the total current IG. The current brake 48 is able to control the magnitude of the bypass current IB through the bypass path 46. In other words: depending on the control of the current brake 48, more or less of the total current IG can be fed through the bypass path 46 assuming appropriate voltage/current ratios—to alter the load current IL and thus the total current IG or adjust them as desired.

The current sink 22 additionally contains a control unit 60. Said control unit is configured to take the measurement voltage UM as a basis for controlling the current brake 48 in regard to the magnitude of the bypass current IB such that, when the switch 40 is closed, a predeterminable total current IG is produced in the current path 30.

The switch 40 is arranged in the current path 30 at the lower supply pole 28b as the first element of the series connection. The connection 32, on the other hand, is arranged in the current path 30 at the upper supply pole 28a as the first element of the series connection. The shunt resistor 36 is arranged in the current path 30 closer to the lower supply pole 28b than the resistor element 42 and the connection 32.

The switch 40 here is a PWM switch for a PWM mode of the LED chain 20. The reason is that, during operation B, the switch 40 is controlled by the PWM control device 10 using the PWM signal 12, in order to open and close the current path 30 according to pulse width modulation and therefore permit or interrupt the flow of current of the total current IG and thus switch the LED chain 20, or the LEDs 24 thereof, on and off according to a PWM.

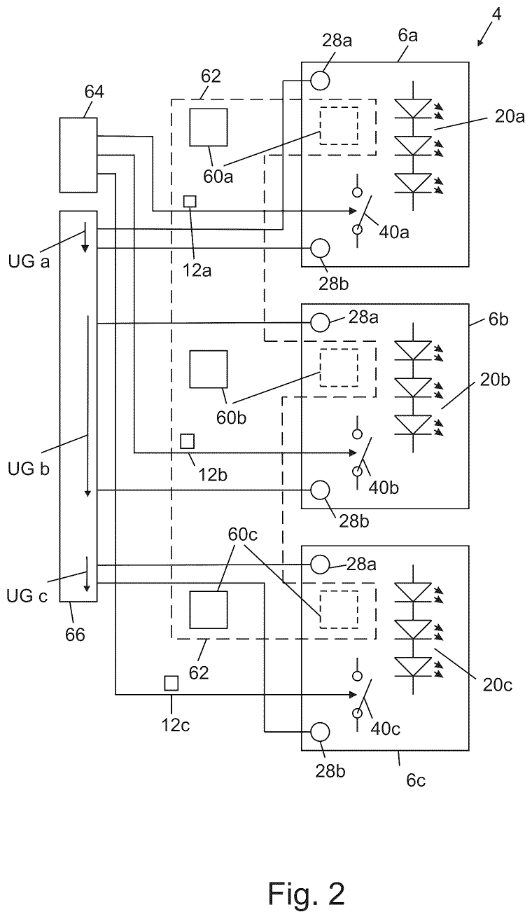

FIG. 2 shows an alternative light device 4 with a total of three light sources 6a-c, all of which are designed according to FIG. 1. However, the respective LED chains 20a-c emit light of different colours during operation. For example, the LED chain 20a is fitted with red-emitting, the LED chain 20b with green-emitting and the LED chain 20c with blue-emitting LEDs 24.

The light device 4 here contains an overall controller 62 of the entire light device 4, which is jointly responsible for controlling all three light sources 6a-c. The respective control units 60a-c of the respective current sinks 22a-c are in the form of parts of the overall controller 62. In other words, the individual light sources 6 do not contain their own dedicated control units 60, but rather these disaggregate to produce corresponding control terminals or control connections or signal paths for the overall controller 62 and partial control functions implemented therein for the respective light source 6a-c. Similarly, the light device 4 contains a central PWM element 64 that undertakes the task of the respective PWM control devices 10 in the light sources 6a-c.

The PWM element 64 provides—as explained analogously above—overall control of all the light sources 6a-c or the respective switches 40a-c thereof.

The light device 4 also contains a supply module 66 that, as already explained, also analogously replaces respective individual energy sources 8 for the light sources 6a-c and collectively produces all of the continuous DC voltages UGa-c of the light sources 6a-c or current sinks 22a-c.

The supply module 66 is also configured to select or change the magnitude of the continuous DC voltage UGa-c for the respective light source 6a-c on the basis of the magnitude of the bypass current IBa-c in the respective light source 6a-c. In particular, the continuous DC voltage UGa-c is lowered in each case to the extent that the bypass current IBa-c becomes preferably zero for the desired total current IGa-c in order to reduce the power loss in the respective light source 6a-c or current sink 22a-c to a minimum.

### LIST OF REFERENCE SIGNS

2 aircraft
4 light device
6 light source
8 energy source
10 PWM control device
12 PWM signal
20 LED chain
22 current sink
24 LED
26a,b contact (LED chain)
28a,b upper, lower supply pole
30 current path
32 connection
34a,b connecting poles (connection)
36 shunt resistor
38 single shunt
40 switch
42 resistor element
44 load resistor
46 bypass path
47 single load resistor
48 current brake
60 control unit
62 overall controller
64 PWM element
66 supply module
B operation
UG continuous DC voltage
GND earth potential
VCC operating potential
IG total current
UM measurement voltage
IL load current
IB bypass current

What is claimed is:

1. A current sink for an LED chain,
having an upper and a lower supply pole that are fed from a continuous DC voltage (UG) during operation (B) as intended,
having a single current path connecting the two supply poles that, during operation (B), carries a total current (IG),
the following being connected in series in the current path:
a two-pole connection for the LED chain,
a shunt resistor that maps the total current (IG) currently flowing through the current path to a present measurement voltage (UM),
a switch for opening or closing the current path,
a controllable resistor element containing a parallel connection comprising a load resistor and a bypass path,
the bypass path containing a controllable current brake that controls the magnitude of a bypass current (IB) through the bypass path,
having a control unit that is connected to the current brake and configured to take the measurement voltage (UM) as a basis for controlling the current brake in regard to the magnitude of the bypass current (IB) such that, when the switch is closed, a predeterminable total current (IG) is produced in the current path.

2. The current sink according to claim 1, wherein the switch is arranged in the current path at the lower supply pole as the first element of the series connection.

3. The current sink according to claim 1, wherein the connection is arranged in the current path at the upper supply pole as the first element of the series connection.

4. The current sink according to claim 1, wherein the shunt resistor is arranged in the current path closer to the lower supply pole than the resistor element and the connection.

5. The current sink according to claim 1, wherein the switch is a PWM switch for a PWM mode of the LED chain.

6. A light source for a light device of an aircraft,
having the current sink according to claim 1,
having the LED chain comprising a plurality of LEDs connected in series, which is connected to the connection.

7. A light device for an aircraft, having at least one light source according to claim 6.

8. A light device according to claim 7, wherein
the light device contains at least two of the light sources and an overall controller for the light device,
the control unit of at least one light source being in the form of part of the overall controller.

9. The light device according to claim 7, wherein
the light device contains a PWM element for controlling at least one of the light sources using a respective PWM signal,
the PWM element being connected to the switch of the respective light source, and the PWM element being configured to control the respective switch using the PWM signal.

10. The light device according to claim 7, wherein
the light device contains a supply module for supplying the supply poles of at least one of the light sources with a respective continuous DC voltage (UGa-c).

11. The light device according to claim 10, wherein the supply module is configured to select or change the magnitude of the continuous DC voltage (UGa-c) for at least one of the light sources on the basis of the magnitude of the bypass current (IBa-c) in the respective light source.
